(19) United States
(12) Patent Application Publication
(10) Pub. No.: US 2014/0023323 A1
(43) Pub. Date: Jan. 23, 2014

(54) OPTICAL CONNECTOR AND FITTED UNIT

(71) Applicant: Yazaki Corporation, Tokyo (JP)

(72) Inventor: Nozomi TSUZAKI, Atsugi-shi (JP)

(73) Assignee: Yazaki Corporation, Tokyo (JP)

(21) Appl. No.: 13/945,363

(22) Filed: Jul. 18, 2013

(30) Foreign Application Priority Data
Jul. 19, 2012 (JP) 2012-160799
Jan. 16, 2013 (JP) 2013-005647

(51) Int. Cl. G02B 6/38

(52) U.S. Cl. CPC G02B 6/3809
USPC 385/77

(57) ABSTRACT

An optical connector includes an optical cable and a connector housing. The optical cable includes an optical fiber having a core and a clad which covers an outer surface of the core, and a sheath covering an outer surface of the optical fiber, and wherein a front end part of the optical fiber is exposed from the sheath, and the front end part including a front end of the optical fiber. The connector housing accommodates the front end part of the optical fiber which is exposed from the sheath and holds a part of the front end part of the optical fiber.

### BACKGROUND

The present invention relates to an optical connector which is connected to a light module such as a light receptacle or a light adapter and enables optical communication with an optical fiber, and a fitted unit which includes the optical connector and the light module.

An optical connector is used to connect an optical fiber to a light module such as a light receptacle or a light adapter to make optical communication possible (for example, refer to JP-A-2011-75829).

A ferrule is used to fix the optical fiber to the optical connector. The optical fiber is fixed to the optical connector when the ferrule is fixed to the front end of the optical fiber, and the ferrule is mounted to the housing of the optical connector. It is described in JP-A-2011-75829 as follows that the ferrule is fixed to the front end of the optical fiber. That is, the built-in optical fiber is a single core optical fiber such as a single core optical fiber core wire or an optical fiber strand, and one longitudinal end side (front end side) of the optical fiber is inserted into an optical fiber leading hole (micro-hole), which is a through hole at the inner side of a capillary part of the ferrule and which is coaxially formed with the central axis of the capillary part, and is adhered and fixed to the capillary part 13 by adhesive (refer to paragraph [0018] of the specification of JP-A-2011-75829).

However, the technique described in JP-A-2011-75829 for fixing the optical fiber to the optical connector requires steps of mounting the ferrule to the front end of the optical fiber and applying the adhesive. Therefore, the productivity is low.

The present invention is made in view of the above circumstances, and the object of the present invention is to provide an optical connector and a fitted unit including the optical connector and a light module so that it is not necessary to use a ferrule when an optical fiber is fixed to the optical connector.

### SUMMARY

In order to achieve the purpose described above, an optical connector according to the invention is characterized by the following (1) to (4).

(1) There is provided an optical connector comprising:

an optical cable that includes:
an optical fiber having a core and a clad which covers an outer surface of the core; and
a sheath covering an outer surface of the optical fiber, and wherein a front end part of the optical fiber is exposed from the sheath, and the front end part including a front end of the optical fiber; and

a connector housing that accommodates the front end part of the optical fiber which is exposed from the sheath and holds a part of the front end part of the optical fiber.

(2) For example, the optical fiber of the optical cable is a hard plastic clad fiber, the optical fiber further includes a jacket which covers an outer surface of the clad, and the connector housing accommodates the front end part of the optical fiber which is exposed from the sheath therein, and presses the outer surface of the jacket to hold the part of the front end part of the optical fiber.

(3) For example, the optical fiber of the optical cable is a plastic optical fiber, and the connector housing accommodates the front end part of the optical fiber which is exposed from the sheath therein, and presses the outer surface of the clad to hold the part of the front end part of the optical fiber.

(4) For example, the optical fiber of the optical cable is a quartz fiber, the optical fiber further includes a jacket which covers an outer surface of the clad, and the connector housing accommodates the front end part of the optical fiber which is exposed from the sheath therein, and presses the outer surface of the jacket to hold the part of the front end part of the optical fiber.

According to the optical connector of the construction of the above (1), it is not necessary to use a ferrule when the optical fiber is fixed to the optical connector.

According to the optical connector of the construction of the above (2), it is not necessary to use a ferrule when the hard plastic cladding fiber (HPCF) is fixed to the optical connector.

According to the optical connector of the construction of the above (3), it is not necessary to use a ferrule when the plastic optical fiber (POF) is fixed to the optical connector.

According to the optical connector of the construction of the above (4), it is not necessary to use a ferrule when the quartz fiber is fixed to the optical connector.

Also, in order to achieve the purpose described above, a fitted unit according to the invention is characterized by the following (5) to (7).

(5) There is provided a fitted unit comprising:

an optical connector including:
an optical cable that has:
   an optical fiber having a core and a clad which covers an outer surface of the core; and
   a sheath covering an outer surface of the optical fiber, and wherein a front end part of the optical fiber is exposed from the sheath, and the front end part including a front end of the optical fiber; and
a connector housing that accommodates the front end part of the optical fiber which is exposed from the sheath and holds a part of the front end part of the optical fiber; and

a light module including:
a fiber optical transceiver which has a light emitting surface for transmitting light between the optical fiber and the fiber optical transceiver; and
a module housing which includes:
   a holding part which holds the fiber optical transceiver; and
   a cylindrical part having a first aperture which faces the light emitting surface and a second aperture into which the front end part of the optical fiber is inserted, and the module housing being engaged with the connector housing,

wherein a core diameter of the optical fiber is larger than a sum of the maximum tolerances allowed for the optical cable, the connector housing, the fiber optical transceiver, and the module housing, respectively.

(6) For example, the optical fiber of the optical cable is a hard plastic clad fiber, the optical fiber further includes a jacket which covers an outer surface of the clad, and the connector housing accommodates the front end part of the optical fiber which is exposed from the sheath therein, and presses the outer surface of the jacket to hold the part of the front end part of the optical fiber.

(7) For example, the optical fiber of the optical cable is a plastic optical fiber, and the connector housing accommodates the front end part of the optical fiber which is exposed from the sheath therein, and presses the outer surface of the clad to hold the part of the front end part of the optical fiber.

According to the fitted unit of the construction of the above (5), it is not necessary to use a ferrule when the optical fiber is fixed to the optical connector.

According to the fitted unit of the construction of the above (6), it is not necessary to use a ferrule when the hard plastic cladding fiber (HPCF) is fixed to the optical connector.

According to the fitted unit of the construction of the above (7), it is not necessary to use a ferrule when the plastic optical fiber (POF) is fixed to the optical connector.

According to the optical connector and the fitted unit including the optical connector and a light module of the present invention, it is not necessary to use a ferrule when an optical fiber is fixed to the optical connector. Therefore, the efficiency of the operation of fixing the optical fiber to the optical connector is improved.

The present invention has been briefly described above. Further, details of the invention will become more apparent after embodiments of the invention described below (hereinafter referred to as “embodiments”) are read with reference to the accompanying figures.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1A is a perspective view when an optical connector according to the present embodiment is viewed from the front end side, FIG. 1B is an exploded perspective view when the optical connector according to the present embodiment is viewed from the front end side, and FIG. 1C is a front view of a hard plastic clad fiber that is connected to the optical connector according to the present embodiment;

FIG. 2A is a perspective view when the optical connector according to the present embodiment is viewed from the rear end side and FIG. 2B is an exploded perspective view when the optical connector according to the present embodiment is viewed from the rear end side;

FIG. 3 is a sectional view which shows the optical connector according to the present embodiment;

FIG. 4A is a perspective view when an optical connector according to the present embodiment is viewed from the front end side, FIG. 4B is an exploded perspective view when the optical connector according to the present embodiment is viewed from the front end side, and FIG. 4C is a front view of a plastic optical fiber that is connected to the optical connector according to the present embodiment;

FIG. 5A is a perspective view when the optical connector according to the present embodiment is viewed from the rear end side and FIG. 5B is an exploded perspective view when the optical connector according to the present embodiment is viewed from the rear end side;

FIG. 6 is a sectional view which shows the optical connector according to the present embodiment;

FIG. 7 is a perspective view of a light module concerning the embodiment of the present invention;

FIG. 8 is a perspective view of the light module concerning the embodiment of the present invention when viewed from the side of an optical port part;

FIG. 9 is a front view of the light module concerning the embodiment of the present invention when viewed from the side of the optical port part;

FIG. 10 is a perspective view of the light module when viewed from the side of holding parts in the housing;

FIG. 11A is a sectional view which shows the internal structure of the light module and FIG. 11B is an expanded sectional view of an XIb part in FIG. 11A;

FIG. 12A is a sectional view of the light module to which the hard plastic clad fiber is connected and FIG. 12B is an expanded sectional view of an XIIb part in FIG. 12A;

FIG. 13A is a sectional view of the light module to which the plastic optical fiber is connected and FIG. 13B is an expanded sectional view of an XIIIb part in FIG. 13A;

FIG. 14A is a perspective view when an optical connector according to the present embodiment is viewed from the front end side, FIG. 14B is an exploded perspective view when the optical connector according to the present embodiment is viewed from the front end side, and FIG. 14C is front view of the quartz fiber connected to the optical connector according to the present embodiment;

FIG. 15A is a perspective view when the optical connector according to the present embodiment is viewed from the rear end side and FIG. 15B is an exploded perspective view when the optical connector according to the present embodiment is viewed from the rear end side;

FIG. 16 is a sectional view which shows the optical connector according to the present embodiment;

FIG. 17A is a sectional view which shows the internal structure of the light module and FIG. 17B is an expanded sectional view of an XVIIb part in FIG. 11A; and

FIG. 18A is a sectional view of the light module to which the quartz fiber is connected and FIG. 18B is an expanded sectional view of an XVIIIb part in FIG. 18A.

### DETAILED DESCRIPTION OF EXEMPLARY EMBODIMENTS

Specific embodiments of the present invention are described below with reference to the figures.

### [Structure of an Optical Connector Connected to a Hard Plastic Clad Fiber]

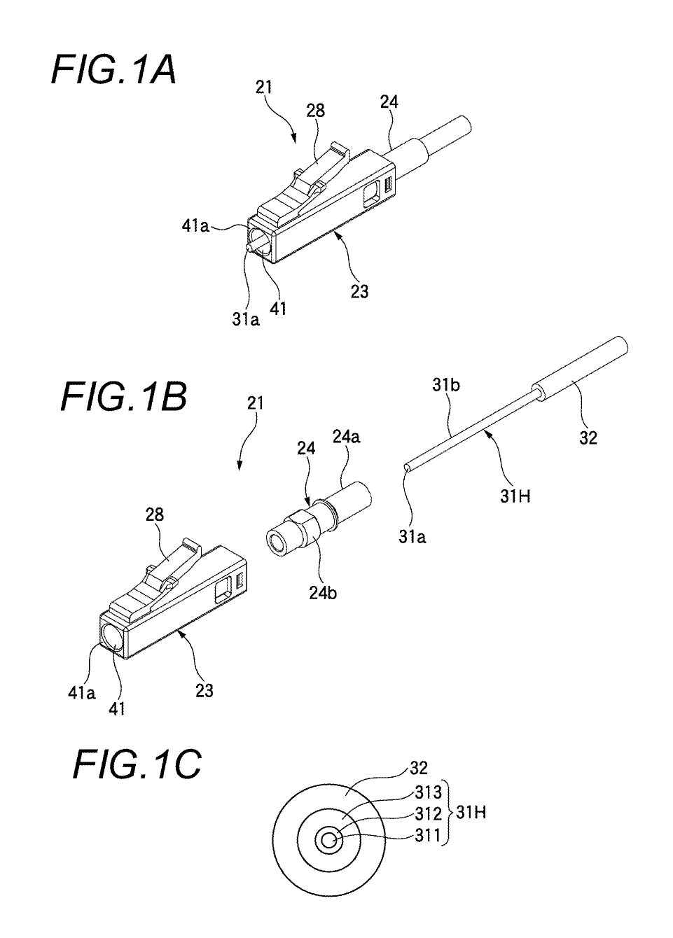

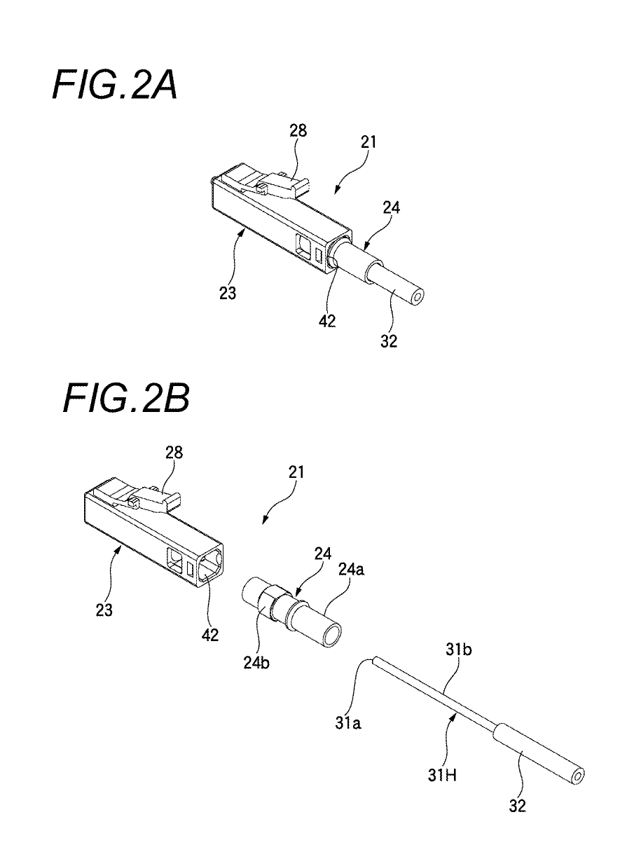

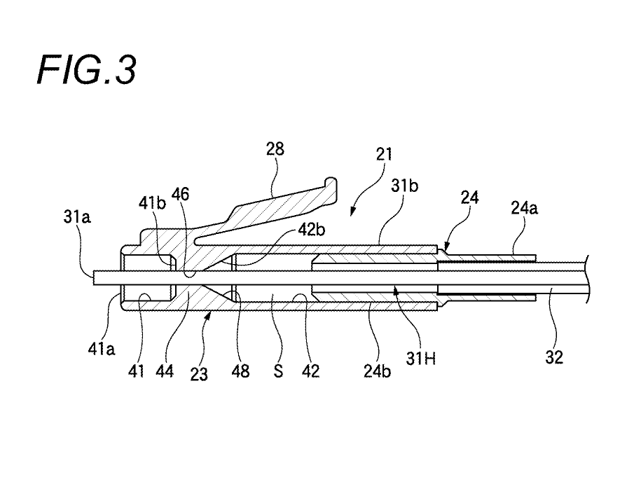

First, the structure of an optical connector according to the present embodiment which is connected to a hard plastic clad fiber is described in detail. FIG. 1A is a perspective view when an optical connector according to the present embodiment is viewed from the front end side. FIG. 1B is an exploded perspective view when the optical connector according to the present embodiment is viewed from the front end side. FIG. 1C is a front view of a hard plastic clad fiber that is connected to the optical connector according to the present embodiment. FIG. 2A is a perspective view when the optical connector according to the present embodiment is viewed from the rear end side. FIG. 2B is an exploded perspective view when the optical connector according to the present embodiment is viewed from the rear end side. FIG. 3 is a sectional view which shows the optical connector according to the present embodiment.

As shown in FIGS. 1A, 1B, 1C, 2A and 2B, an optical connector 21 includes, for example, a housing 23 molded by resin such as plastics and a tubular strength member 24 formed of metal.

A hard plastic clad fiber core wire 31H connected to the optical connector 21 has a core 311, a clad 312 covering an outer surface of the core 311, and a jacket 313 covering an outer surface of the clad 312. An optical cable is formed when the outer peripheral surface of the jacket 313 of the hard plastic clad fiber core wire 31H is covered with a sheath 32. A front end part 31b including a front end 31a of the hard plastic clad fiber core wire 31H is exposed from the sheath 32. The hard plastic clad fiber core wire 31H is a hard plastic clad fiber (HPCF: Hard Plastic Clad Fiber) in which the core 311 is formed of quartz glass, the clad 312 is formed of high hardness plastic, and the jacket 313 is formed of resin. Because a core diameter of the hard plastic clad fiber is large, the required optical axis precision of a source of light is relatively low, and thus a fitted unit including the optical connector and a light module can be realized in a low cost way.

As shown in FIG. 3, the housing 23 constructing a part of the optical connector 21 has a front cylindrical part (first cylindrical part) 41 of a bottomed cylindrical shape, and a back cylindrical part (second cylindrical part) 42 of a bottomed cylindrical shape. The front cylindrical part 41 is located at the side that is near the front end 31a of the hard plastic clad fiber core wire 31H, and the back cylindrical part 42 is located at the side opposite to the front cylindrical part 41, namely, the side that is far from the front end 31a of the hard plastic clad fiber core wire 31H. For convenience, in the present specification and the figures, the side of the front cylindrical part 41 (the left side of FIG. 3) is referred to as front side, and the side of the back cylindrical part 42 (the right side of FIG. 3) back side.

The front cylindrical part 41 of the housing 23 is an insertion part which is inserted and connected to a light module such as a light receptacle or a light adapter which is a connection counterpart of the optical connector 21.

A joining part 44 which forms a bottom 41b of the front cylindrical part 41 and a bottom 42b of the back cylindrical part 42 is formed with a through hole 46. The through hole 46 communicates the bottom 41b of the front cylindrical part 41 and the bottom 42b of the back cylindrical part 42. The bottom 41b of the front cylindrical part 41 and the bottom 42b of the back cylindrical part 42 are joined by the through hole 46. The inside diameter of the through hole 46 is formed to be slightly larger than the outer diameter of the jacket 313 of the hard plastic clad fiber core wire 31H so that the hard plastic clad fiber core wire 31H may be inserted into the through hole 46. Therefore, when the hard plastic clad fiber core wire 31H is inserted into the through hole 46, the outer surface of the jacket 313 is pressed by the through hole 46, and a part of the front end part 31b is held by the housing 23.

With the through hole 46, when the inserted hard plastic clad fiber core wire 31H slides on the wall that forms the through hole 46, the hard plastic clad fiber core wire 31H is aligned to the central axis of the housing 23, and is extended to the front end side in a straight state because the peculiarity such as the bend of the hard plastic clad fiber core wire 31H is corrected. That is, the through hole 46 serves as an aligning and correcting part that aligns and corrects the hard plastic clad fiber core wire 31H.

The hard plastic clad fiber core wire 31H is inserted into the housing 23 from the rear side of the back cylindrical part 42, which opens at the back end, into the through hole 46. Thus, the front end part 31b, which is exposed from the sheath 32, of the hard plastic clad fiber core wire 31H is accommodated inside the housing 23.

The inside diameter of the back cylindrical part 42 becomes smaller towards the through hole 46. That is, the bottom 42b of the back cylindrical part 42 has a guide part 48 of a taper shape which gradually becomes narrower towards the through hole 46. Therefore, the hard plastic clad fiber core wire 31H, which is inserted from the rear side of the back cylindrical part 42, is guided in the guide part 48, led to the through hole 46 and inserted smoothly.

One end side (crimped part 24a) of the strength member 24 is held (crimped and fixed) to the outer surface at the end of the sheath 32 of the hard plastic clad fiber core wire 31H. A part at the other end side of the strength member 24 is fitted into the back cylindrical part 42 of the housing 23, and is accommodated inside the back cylindrical part 42. Thereby, the back cylindrical part 42 closely contacts the outer surface of the part of the strength member 24.

Relative to the housing 23, the front end 31a of the hard plastic clad fiber core wire 31H projects from a front edge 41a of the front cylindrical part 41, and the front end 31a is placed at a predetermined position from the front edge 41a of the front cylindrical part 41.

The housing 23 of the optical connector 21 is formed with a latching part 28, and when the optical connector 21 is inserted into a light module, the latching part 28 maintains a state that the optical connector 21 is engaged and connected with the housing of the light module.

The structure of the optical connector to which the hard plastic clad fiber is fixed according to the present embodiment is described in detail above. With the above optical connector, when the hard plastic clad fiber core wire 31H is inserted into the through hole 46, the outer surface of the jacket 313 is pressed by the through hole 46, and a part of the front end part 31b is held by the housing 23. Thereby, the hard plastic clad fiber core wire 31H is fixed to the optical connector. Therefore, according to the optical connector according to the present embodiment, because the optical fiber and the optical connector are not fixed by using a ferrule, in comparison with the traditional case of fixing by using the ferrule, the work efficiency increases and the productivity can be improved.

[Structure of an Optical Connector Connected to a Plastic Optical Fiber]

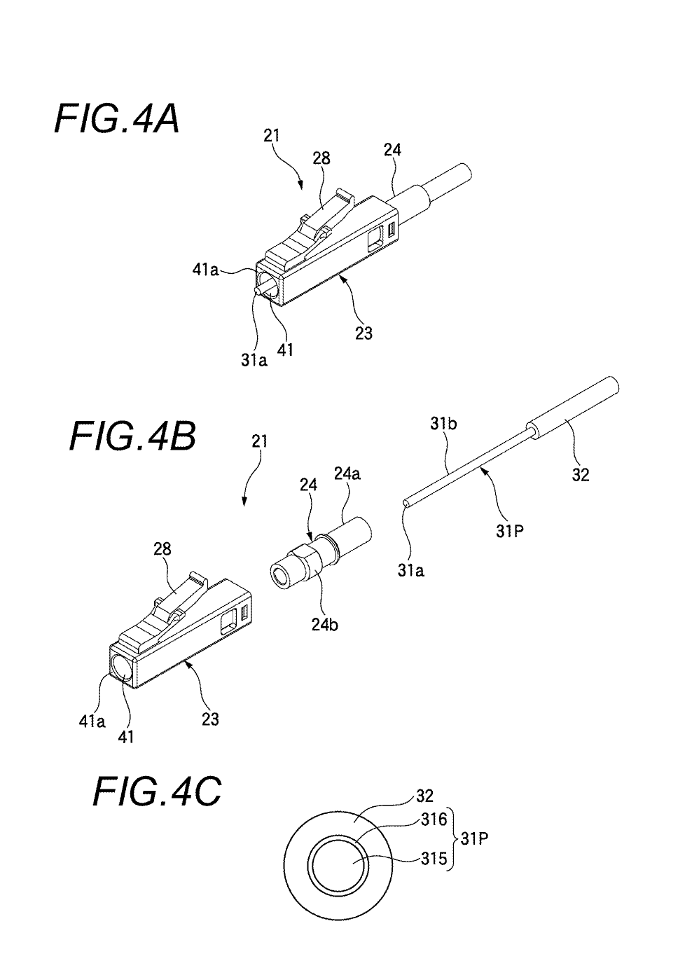

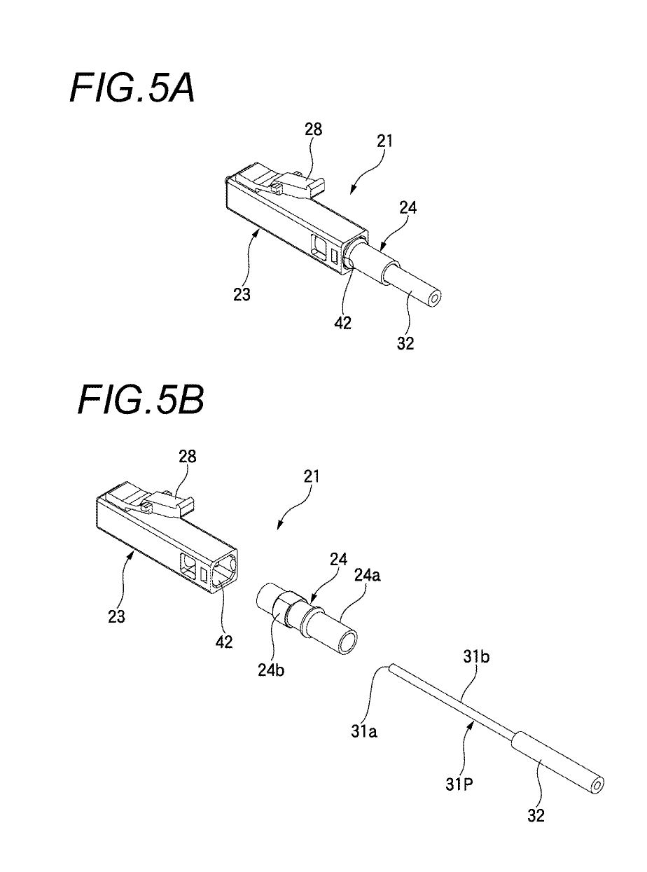

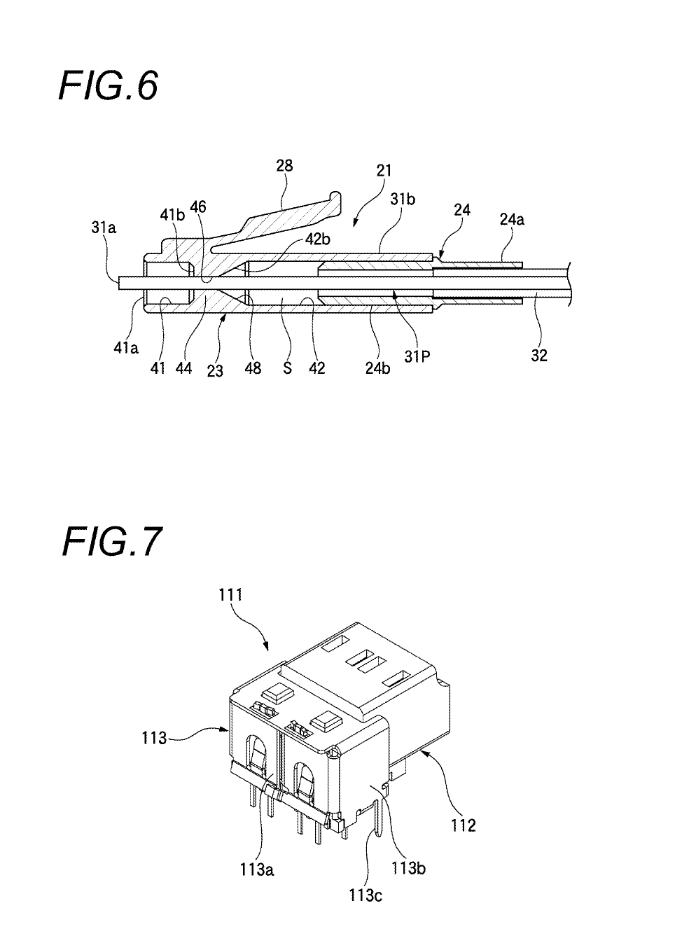

Next, the structure of an optical connector according to the present embodiment which is connected to a plastic optical fiber is described in detail. FIG. 4A is a perspective view when an optical connector according to the present embodiment is viewed from the front end side. FIG. 4B is an exploded perspective view when the optical connector according to the present embodiment is viewed from the front end side. FIG. 4C is a front view of a plastic optical fiber that is connected to the optical connector according to the present embodiment. FIG. 5A is a perspective view when the optical connector according to the present embodiment is viewed from the rear end side. FIG. 5B is an exploded perspective view when the optical connector according to the present embodiment is viewed from the rear end side. FIG. 6 is a sectional view which shows the optical connector according to the present embodiment.

As shown in FIGS. 4A, 4B, 4C, 5A and 5B, an optical connector 21 according to the present embodiment includes, for example, a housing 23 molded by resin such as plastics and a tubular strength member 24 formed of metal.

A plastic optical fiber 31P connected to the optical connector 21 has a core 315 and a clad 316 covering the outer surface of the core 315. An optical cable is formed when the outer peripheral surface of the clad 316 of the plastic optical fiber 31P is covered with a sheath 32. A front end part 31b including a front end 31a of the plastic optical fiber 31P is exposed from the sheath 32. The plastic optical fiber 31P is a plastic optical fiber (POF: Plastic Optical Fiber) which is formed of the core 315 and the clad 316, and is superior in the noise-resistant performance.

As shown in FIG. 6, the housing 23 constructing a part of the optical connector 21 has a front cylindrical part (first cylindrical part) 41 of a bottomed cylindrical shape, and a back cylindrical part (second cylindrical part) 42 of a bottomed cylindrical shape. The front cylindrical part 41 is located at the side that is near the front end 31a of the plastic optical fiber 31P, and the back cylindrical part 42 is located at the side opposite to the front cylindrical part 41, namely, the side that is far from the front end 31a of the plastic optical fiber 31P. For convenience, in the present specification and the figures, the side of the front cylindrical part 41 (the left side of FIG. 6) is referred to as front side, and the side of the back cylindrical part 42 (the right side of FIG. 6) back side.

The front cylindrical part 41 of the housing 23 is an insertion part which is inserted and connected to a light module such as a light receptacle or a light adapter which is a connection counterpart of the optical connector 21.

A joining part 44 which forms a bottom 41b of the front cylindrical part 41 and a bottom 42b of the back cylindrical part 42 is formed with a through hole 46. The through hole 46 communicates the bottom 41b of the front cylindrical part 41 and the bottom 42b of the back cylindrical part 42. The bottom 41b of the front cylindrical part 41 and the bottom 42b of the back cylindrical part 42 are joined by the through hole 46. The inside diameter of the through hole 46 is formed to be slightly larger than the outer diameter of the clad 316 of the plastic optical fiber 31P so that the plastic optical fiber 31P may be inserted into the through hole 46. Therefore, when the plastic optical fiber 31P is inserted into the through hole 46, the outer surface of the clad 316 is pressed by the through hole 46, and a part of the front end part 31b is held by the housing 23.

With the through hole 46, when the inserted plastic optical fiber 31P slides on the wall that forms the through hole 46, the plastic optical fiber 31P is aligned to the central axis of the housing 23, and is extended to the front end side in a straight state because the peculiarity such as the bend of the plastic optical fiber 31P is corrected. That is, the through hole 46 serves as an aligning and correcting part that aligns and corrects the plastic optical fiber 31P.

The outer diameter of the clad 316 of the plastic optical fiber 31P is set to 1000 [μm], and, on the other hand, the outer diameter of the jacket 313 of the hard plastic clad fiber core wire 31H is set to, for example, 900 [μm]. Therefore, a common optical connector can be applied to the plastic optical fiber 31P and the hard plastic clad fiber core wire 31H the outer diameters of whose parts that are guided in the through hole 46 are close. Therefore, it is not necessary to prepare exclusive optical connectors respectively for the plastic optical fiber 31P and the hard plastic clad fiber core wire 31H, and the number of components can be reduced.

The plastic optical fiber 31P is inserted into the housing 23 from the rear side of the back cylindrical part 42, which opens at the back end, into the through hole 46. Thus, the front end part 31b, which is exposed from the sheath 32, of the plastic optical fiber 31P is accommodated inside the housing 23.

The inside diameter of the back cylindrical part 42 becomes smaller towards the through hole 46. That is, the bottom 42b of the back cylindrical part 42 has a guide part 48 of a taper shape which gradually becomes narrower towards the through hole 46. Therefore, the plastic optical fiber 31P, which is inserted from the rear side of the back cylindrical part 42, is guided in the guide part 48, led to the through hole 46 and inserted smoothly.

One end side (crimped part 24a) of the strength member 24 is held (crimped and fixed) to the outer surface at the end of the sheath 32 of the plastic optical fiber 31P. A part at the other end side of the strength member 24 is fitted into the back cylindrical part 42 of the housing 23, and is accommodated inside the back cylindrical part 42. Thereby, the back cylindrical part 42 closely contacts the outer surface of the part of the strength member 24.

Relative to the housing 23, the front end 31a of the plastic optical fiber 31P projects from a front edge 41a of the front cylindrical part 41, and the front end 31a is placed at a predetermined position from the front edge 41a of the front cylindrical part 41.

The housing 23 of the optical connector 21 is formed with a latching part 28, and when the optical connector 21 is inserted into a light module, the latching part 28 maintains a state that the optical connector 21 is engaged and connected with the housing of the light module.

The structure of the optical connector to which the plastic optical fiber is fixed according to the present embodiment is described in detail above. With the above optical connector, when the plastic optical fiber 31P is inserted into the through hole 46, the outer surface of the clad 316 is pressed by the through hole 46, and a part of the front end part 31b is held by the housing 23. Thereby, the plastic optical fiber 31P is fixed to the optical connector. Therefore, according to the optical connector according to the present embodiment, because the optical fiber and the optical connector are not fixed by using a ferrule, in comparison with the traditional case of fixing by using the ferrule, the work efficiency increases and the productivity can be improved.

### [Structure of an Optical Connector Connected to a Quartz Fiber]

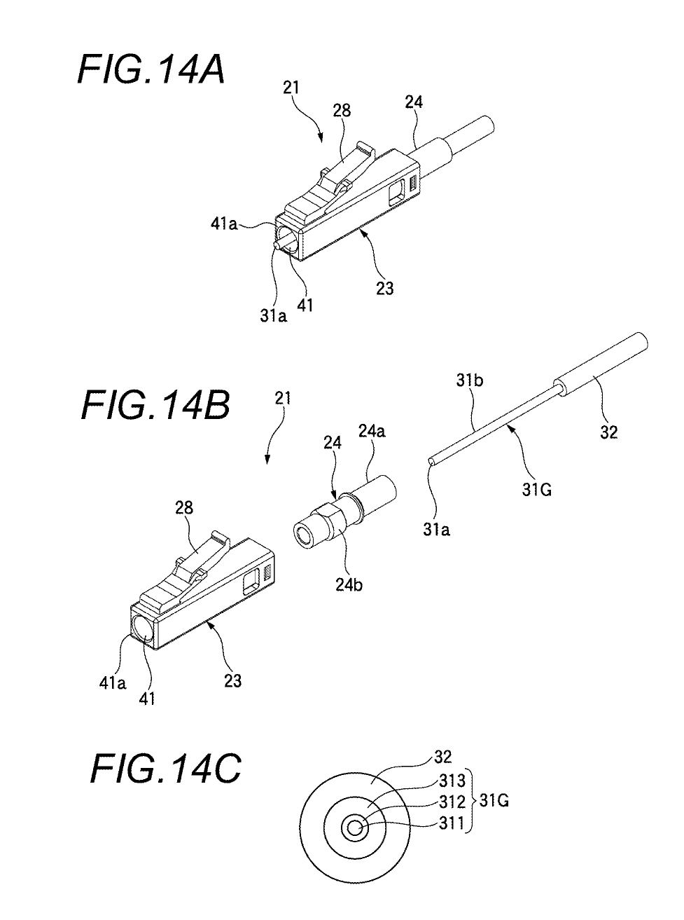

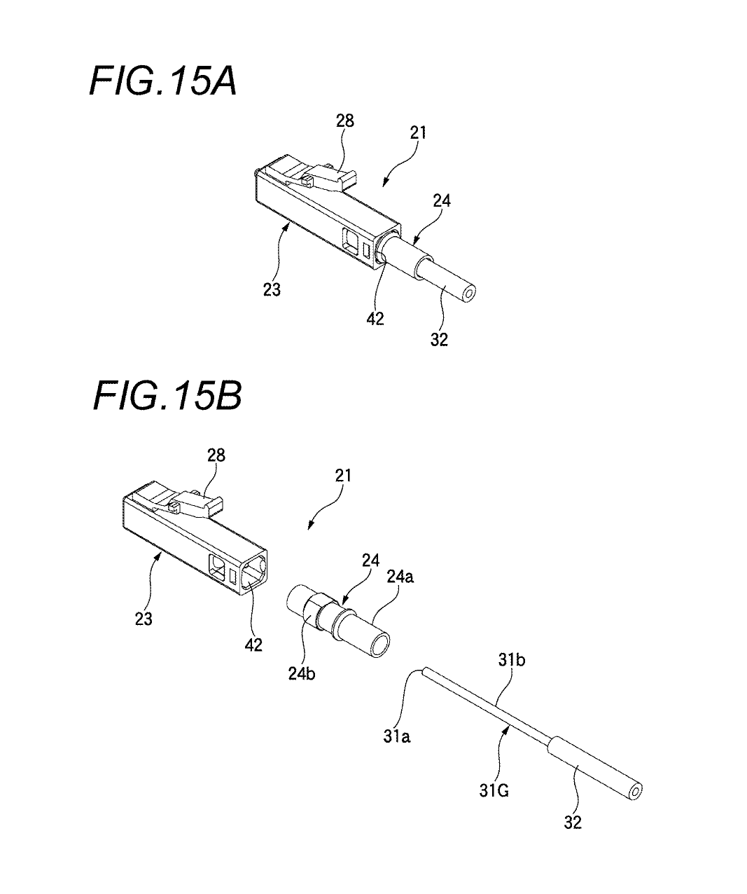

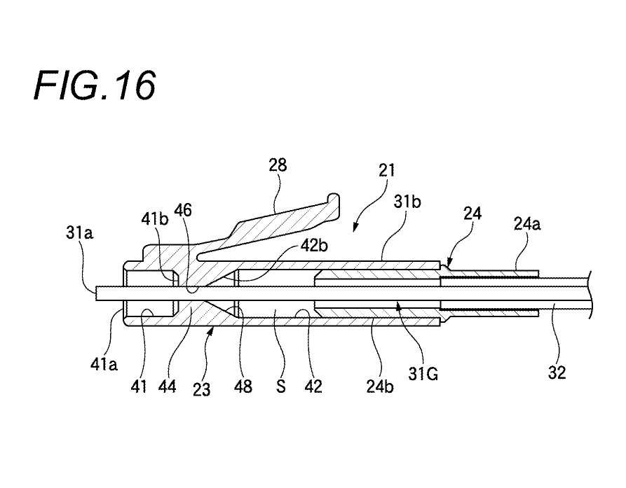

Next, the structure of an optical connector according to the present embodiment which is connected to a quartz fiber is described in detail. FIG. 14A is a perspective view when an optical connector according to the present embodiment is viewed from the front end side. FIG. 14B is an exploded perspective view when the optical connector according to the present embodiment is viewed from the front end side. FIG. 14C is front view of the quartz fiber connected to the optical connector according to the present embodiment. FIG. 15A is a perspective view when the optical connector according to the present embodiment is viewed from the rear end side. FIG. 15B is an exploded perspective view when the optical connector according to the present embodiment is viewed from the rear end side. FIG. 16 is a sectional view which shows the optical connector according to the present embodiment.

As shown in FIGS. 14A, 14B, 14C, 15A and 15B, an optical connector 21 according to the present embodiment includes, for example, a housing 23 molded by resin such as plastics and a tubular strength member 24 formed of metal.

A quartz fiber core wire 31G connected to the optical connector 21 has a core 311, a clad 312 covering the outer surface of the core 311, and a jacket 313 covering the outer surface of the clad 312. An optical cable is formed when the outer peripheral surface of the jacket 313 of the quartz fiber core wire 31G is covered with a sheath 32. A front end part 31b including a front end 31a of the quartz fiber core wire 31G is exposed from the sheath 32. The optical axis precision that a quartz fiber requires in a source of light is relatively high. To support the optical connector 21, it is desirable that the light source (a surface emitting laser or LED) of the FOT (Fiber Optical Transceiver) in the light module connected with the quartz fiber 31G is mounted near the surface inside the package as much as possible. The fitted unit can be realized in a low cost way by the light module, which has the built-in FOT whose light source is mounted near the surface, and the optical connector.

As shown in FIG. 16, the housing 23 constructing a part of the optical connector 21 has a front cylindrical part (first cylindrical part) 41 of a bottomed cylindrical shape, and a back cylindrical part (second cylindrical part) 42 of a bottomed cylindrical shape. The front cylindrical part 41 is located at the side that is near the front end 31a of the quartz fiber core wire 31G, and the back cylindrical part 42 is located at the side opposite to the front cylindrical part 41, namely, the side that is far from the front end 31a of the quartz fiber core wire 31G. For convenience, in the present specification and the figures, the side of the front cylindrical part 41 (the left side of FIG. 16) is referred to as front side, and the side of the back cylindrical part 42 (the right side of FIG. 16) back side.

The front cylindrical part 41 of the housing 23 is an insertion part which is inserted and connected to a light module such as a light receptacle or a light adapter which is a connection counterpart of the optical connector 21.

A joining part 44 which forms a bottom 41b of the front cylindrical part 41 and a bottom 42b of the back cylindrical part 42 is formed with a through hole 46. The through hole 46 communicates the bottom 41b of the front cylindrical part 41 and the bottom 42b of the back cylindrical part 42. The bottom 41b of the front cylindrical part 41 and the bottom 42b of the back cylindrical part 42 are joined by the through hole 46. The inside diameter of the through hole 46 is formed to be slightly smaller than the outer diameter of the jacket 313 of the quartz fiber core wire 31G so that the quartz fiber core wire 31G may be inserted into the through hole 46. Therefore, when the quartz fiber core wire 31G is inserted into the through hole 46, the outer surface of the jacket 313 is pressed by the through hole 46, and a part of the front end part 31b is held by the housing 23.

With the through hole 46, when the inserted quartz fiber core wire 31G slides on the wall that forms the through hole 46, the quartz fiber core wire 31G is aligned to the central axis of the housing 23, and is extended to the front end side in a straight state because the peculiarity such as the bend of the quartz fiber core wire 31G is corrected. That is, the through hole 46 serves as an aligning and correcting part that aligns and corrects the quartz fiber core wire 31G.

The quartz fiber core wire 31G is inserted into the housing 23 from the rear side of the back cylindrical part 42, which opens at the back end, into the through hole 46. Thus, the front end part 31b, which is exposed from the sheath 32, of the quartz fiber core wire 31G is accommodated inside the housing 23.

The inside diameter of the back cylindrical part 42 becomes smaller towards the through hole 46. That is, the bottom 42b of the back cylindrical part 42 has a guide part 48 of a taper shape which gradually becomes narrower towards the through hole 46. Therefore, the quartz fiber core wire 31G, which is inserted from the rear side of the back cylindrical part 42, is guided in the guide part 48, led to the through hole 46 and inserted smoothly.

One end side (crimped part 24a) of the strength member 24 is held (crimped and fixed) to the outer surface of the quartz fiber core wire 31G. A part at the other end side of the strength member 24 is fitted into the back cylindrical part 42 of the housing 23, and is accommodated inside the back cylindrical part 42. Thereby, the back cylindrical part 42 closely contacts the outer surface of the part of the strength member 24.

Relative to the housing 23, the front end 31a of the quartz fiber core wire 31G projects from a front edge 41a of the front cylindrical part 41, and the front end 31a is placed at a predetermined position from the front edge 41a of the front cylindrical part 41.

The housing 23 of the optical connector 21 is formed with a latching part 28, and when the optical connector 21 is inserted into a light module, the latching part 28 maintains a state that the optical connector 21 is engaged and connected with the housing of the light module.

The structure of the optical connector to which the quartz fiber is fixed according to the present embodiment is described in detail above. With the above optical connector, when the quartz fiber core wire 31G is inserted into the through hole 46, the outer surface of the jacket 313 is pressed by the through hole 46, and a part of the front end part 31b is held by the housing 23. Thereby, the quartz fiber core wire 31G is fixed to the optical connector. Therefore, according to the optical connector according to the present embodiment, because the optical fiber and the optical connector are not fixed by using a ferrule, in comparison with the traditional case of fixing by using the ferrule, the work efficiency increases and the productivity can be improved.

It is usual to use a ferrule to fix an optical fiber and an optical connector. This depends on the following technical thought. That is, when the optical connector and a light module is fitted to each other, it is to be avoided that transmission loss occurs for the light transmitted from the light emitting element of the light module to the optical fiber. In the traditional invention that is made based on the technical thought, the light module includes a condensing lens, and the light emitted from the light emitting element is condensed by the condensing lens and irradiated towards the front end of the optical fiber. On the other hand, with the optical connector, the optical fiber is positioned by the ferrule so that the front end of the optical fiber is located at the focus of the condensing lens of the light module. Such a technical thought requires that the optical fiber is highly precisely positioned, and therefore does not lead a motive to fix the optical fiber to the optical connector without a ferrule. It may be said that the present invention in which the hard plastic clad fiber core wire 31H, the plastic optical fiber 31P or the quartz fiber core wire 31G is fixed to the optical connector without using a ferrule is based on a technique thought that is different from the above technology thought.

Particularly, when the optical fiber fixed to the optical connector is the hard plastic clad fiber core wire 31H or when the optical fiber fixed to the optical connector is the plastic optical fiber 31P, it is expected that the transmission loss can be endured sufficiently in practical use. To describe this in detail, fitted units including the optical connectors and a light module are described as follows.

### [Structure of a Light Module]

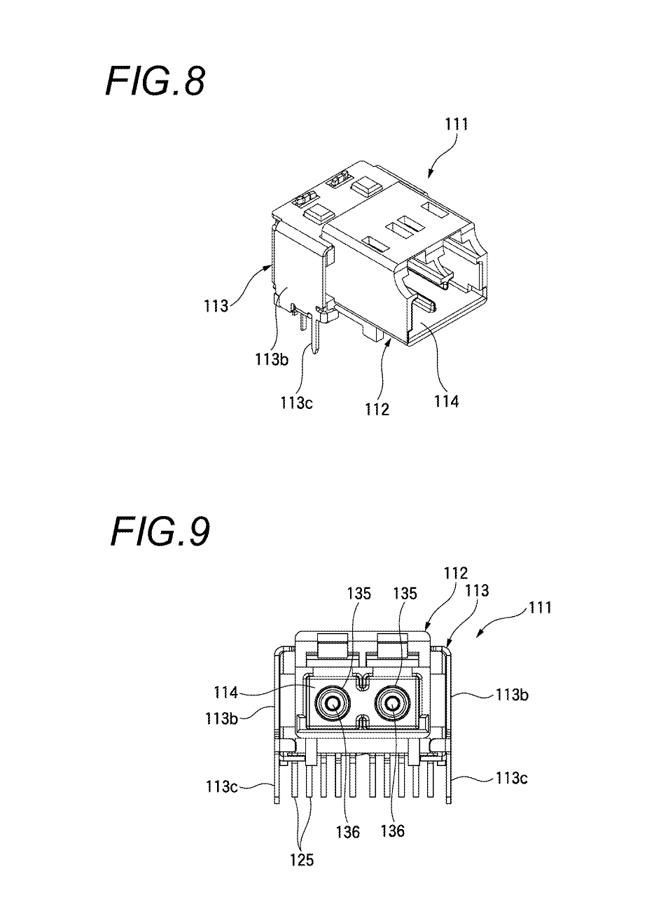

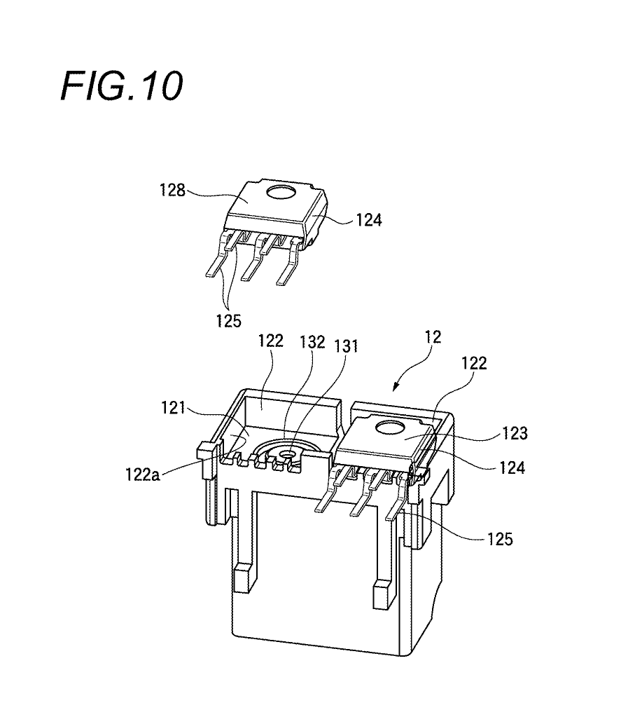

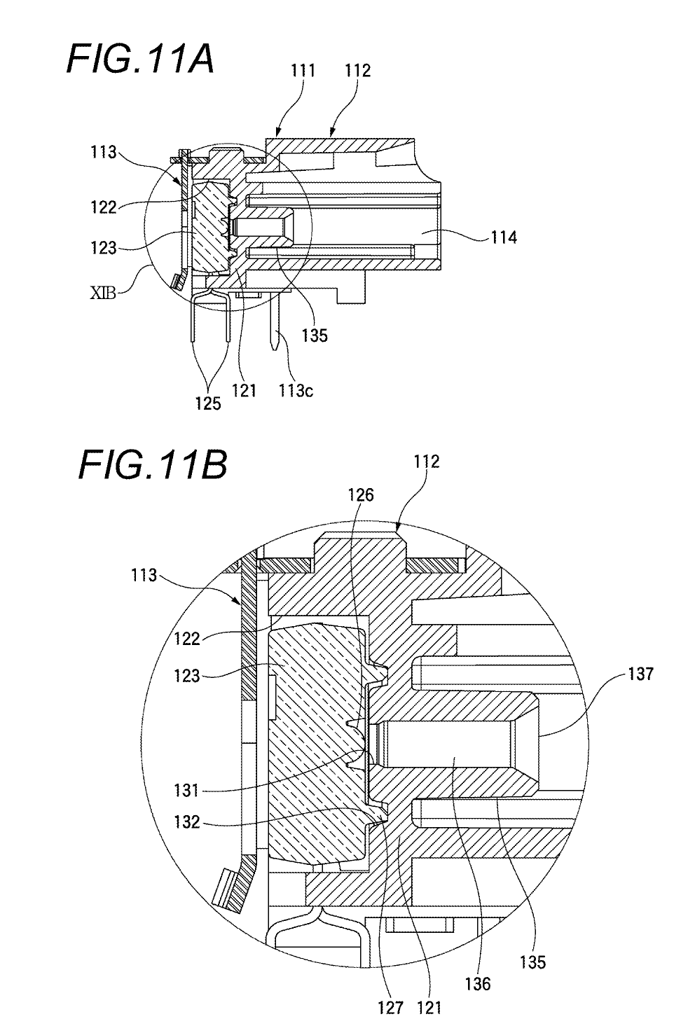

First, the structure of a light module concerning the embodiment of the present invention is described. FIG. 7 is a perspective view of the light module concerning the embodiment of the present invention. FIG. 8 is a perspective view of the light module concerning the embodiment of the present invention when viewed from the side of an optical port part. FIG. 9 is a front view of the light module concerning the embodiment of the present invention when viewed from the side of the optical port part. FIG. 10 is a perspective view of the light module when viewed from the side of holding parts in the housing. FIG. 11A is a sectional view which shows the internal structure of the light module. FIG. 11B is an expanded sectional view of an XIb part in FIG. 11A.

As shown in FIGS. 7 and 8, a light module 111 according to the present embodiment is, for example, a light receptacle constructing a part of the light connection used for the optical communication of OA (Office Automation), FA (Factory Automation), in-vehicle apparatuses or the like. The light module 111 is mounted onto a circuit board which is built in various apparatuses, and includes a housing 112 which is formed of resin, and a metal shield case 113 which is attached to one end of the housing 112.

As shown in FIG. 9, an optical port part 114 is formed at the other end side of the housing 112, and an optical connector is inserted/removed into/from the optical port part 114.

The shield case 113 has a front plate part 113a and side plate parts 113b which are provided at two sides of the front plate part 113a, and is formed into a U shape when viewed from top. Thereby, by attaching the shield case 113 to the housing 112, one end and two side parts at the side of the one end of the housing 112 are covered by the shield case 113. Terminal parts 113c which extend downward are formed at the side plate parts 113b of the shield case 113.

As shown in FIGS. 10, 11A and 11B, the housing 112 is formed with a separating wall 121 that define the one end side and the other end side.

The housing 112 has two holding parts 122 which are concavely formed at the one end side, and an FOT (Fiber Optical Transceiver) 123 which is a fiber optical transceiver having light emitting elements and an FOT 128 having light receiving elements are mounted to these holding parts 122. Each of these FOT 123 and FOT 128 has an element body 124 and a plurality of leads 125 which extend from the element body 124. The holding parts 122 are formed with cut parts 122a at the lower side of the housing 112, and the leads 125 of the FOT 123 are drawn out from the cut parts 122a to the lower side of the housing 112.

The FOT 123 is provided with a light emitting surface 126 which is formed into a semi-spherical shape in the center of the surface at the side of the element body 124. The light emitting surface 126 is a light emitting surface from which light is emitted. Light is emitted from the light emitting surface 126 which is formed into a semi-spherical shape, towards a through hole 136 of a cylindrical part 135 to be described below. The FOT 123 does not condense light emitted from the light emitting elements, and the light is irradiated towards the front end of an optical fiber with a relatively wide angle.

An annular projection 127 around the light emitting surface 126 is formed on the surface of the FOT 123 at the side of the element body 124 where the light emitting surface 126 is provided.

The separating wall 121 is formed with an aperture 131. The surface of the separating wall 121 at the side of the holding parts 122 is formed with an annular groove 132 around the aperture 131, and the annular projection 127 of the FOT 123 accommodated in the holding part 122 is fitted in the annular groove 132. When the projection 127 is fitted in the groove 132, the light emitting surface 126 of the FOT 123 is positioned and arranged at a position that faces the aperture 131. The FOT 123 which is mounted and accommodated in the holding part 122 of the housing 112 is covered by the shield case 113 attached to the housing 112.

The separating wall 121 of the housing 112 is formed with a cylindrical part 135 projecting toward the optical port part 114. The cylindrical part 135 has a through hole 136 in the center, and the aperture of the through hole 136 at the side of the holding part 122 becomes the aperture 131 (first aperture) that faces the light emitting surface 126 of the FOT 123. The aperture of the through hole 136 at the other side becomes an aperture (second aperture) 137 through which the optical fiber is inserted.

The above light module 111 is mounted onto a circuit board which is built in various apparatuses. The terminal parts 113c of the shield case 113 and the leads 125 of the FOT 123 are inserted into through holes of the circuit board, and are soldered to be electrically connected to a conductor pattern. The terminal parts 113c of the shield case 113 are electrically connected to the conductor pattern that is the ground of the circuit board.

An optical connector including an optical fiber of different standards can be connected to the optical port part 114 of the light module 111. In this embodiment, the optical fiber of different standards refers to a hard plastic clad fiber, a plastic optical fiber or a quartz fiber.

By connecting an optical connector, to which a hard plastic clad fiber, a plastic optical fiber or a quartz fiber is connected, to the light module 111, it is possible to transmit light from the light emitting surface 126 of the FOT 123. With the light module 111, because the FOT 123 which is mounted to and accommodated in the holding part 122 of the housing 112 is covered by the shield case 113, the influence of the electromagnetic noise is controlled, and signals may be well transmitted.

### [An Example of Structures of Fitting an Optical Connector and the Light Module]

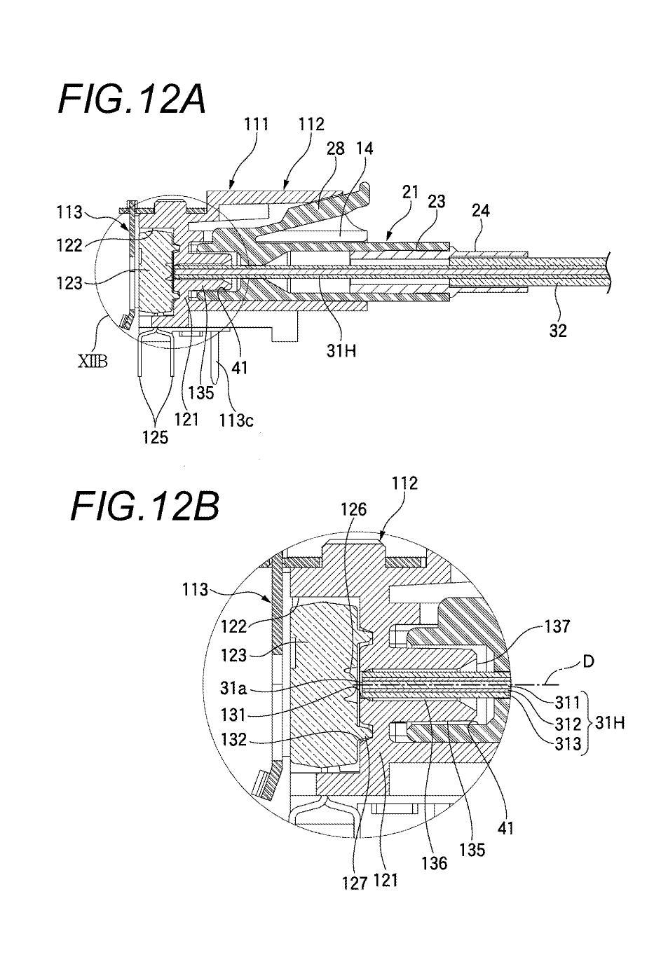

Next, it is described that the optical connectors according to the present embodiments describe above are connected to the light module 111. Here, it is described that the optical connector 21 to which the hard plastic clad fiber core wire 31H is fixed is fixed to the light module 111. FIG. 12A is a sectional view of the light module to which the hard plastic clad fiber is connected. FIG. 12B is an expanded sectional view of an XIIb part in FIG. 12A.

As shown in FIGS. 12A and 12B, the optical connector 21 described above is attached to an end of the hard plastic clad fiber core wire 31H. In terms of the properties of the hard plastic clad fiber core wire 31H, it is expected that the front end of the hard plastic clad fiber core wire 31H may be close to or contact the light emitting surface 126 of the FOT 123.

When the optical connector 21 described above is inserted into the optical port part 114 of the light module 111, an end of the hard plastic clad fiber core wire 31H is inserted from the aperture 137 into the cylindrical part 135 of the light module 111.

Furthermore, when the optical connector 21 is inserted into the optical port part 114 of the light module 111, the cylindrical part 135 is fitted with the front cylindrical part 41 of the optical connector 21.

Then, the end of the hard plastic clad fiber core wire 31H is inserted into the through hole 136 of the cylindrical part 135 of the light module 111. At this time, while the jacket 313 of the hard plastic clad fiber core wire 31H is guided by the through hole 136, the jacket 313 plays a role of protecting the core 311 and the clad 312. The end face of the core 311 of the hard plastic clad fiber core wire 31H is placed at the aperture 131, and placed at a proximate position or a contact position opposed to the light emitting surface 126 of the FOT 123.

In this state, the latching part 28 of the optical connector 21 engages with the housing 112 of the light module 111, and a connected state of the optical connector 21 to the light module 111 is maintained.

Thereby, the light module 111 becomes in a state that it is possible to well transmit light between the hard plastic clad fiber core wire 31H and the light emitting surface 126 of the FOT 123.

For the fitted unit in which the optical connector and the light module are fitted as above, it is expected that the transmission loss of the light transmitted from the light emitting surface 126 of the light module 111 to the end face of the core 311 of the hard plastic clad fiber core wire 31H can be sufficiently endured in practical use. This greatly depends on the structure of the hard plastic clad fiber core wire 31H and the position where the end face of the core 311 of the hard plastic clad fiber core wire 31H is placed.

Although light is irradiated from the light emitting surface 126 of the FOT 123 towards the front end of the optical fiber with a relatively wide angle, the light among the above light that is transmitted along a front direction D (rightward in the center in FIGS. 12A 12B) from the front end of the light emitting surface 126 has the highest strength. If the light that has the highest strength among the light that is irradiated from the light emitting surface 126 is incident on the front end of the optical fiber, the optical communication that can be endured sufficiently in practical use can be realized.

Thus, when the optical connector and the light module is fitted to each other, the position relationship between the front end of the light emitting surface 126 of the FOT 123 and the core 311 of the hard plastic clad fiber core wire 31H is considered. The FOT 123 is held in the holding part 122 of the housing 112. The position of the front end of the light emitting surface 126 of the FOT 123 may be deviated only an amount of S1, which is a sum of the maximum tolerance allowed concerning the external dimension of the FOT 123 and the maximum tolerance allowed concerning the inside diameter dimension of the front cylindrical part 41 of the housing 112, from a standard when there is no deviation at all in the dimensions of the manufactured FOT 123 and the housing 112. On the other hand, the hard plastic clad fiber core wire 31H is held by the through hole 46 of the housing 23. The position of the core 311 may be deviated only an amount of S2, which is a sum of the maximum tolerance allowed concerning the external dimension of the jacket 313 of the hard plastic clad fiber core wire 31H and the maximum tolerance allowed concerning the inside diameter dimension of the through hole 46 of the housing 23, from a standard when there is no deviation at all in the dimensions of the manufactured hard plastic clad fiber core wire 31H and the housing 23. Therefore, in the positional relation between the front end of the light emitting surface 126 of the FOT 123 and the core 311 of the hard plastic clad fiber core wire 31H, it is possible to deviate an amount of S3, which is a sum of the above sum S1 and the above sum S2, from a standard when there is no deviation at all in the dimensions of the manufactured FOT 123, the housing 112, the hard plastic clad fiber core wire 31H and the housing 23.

However, in the hard plastic clad fiber core wire 31H, it is defined as a specification that the diameter of the core 311 is 200 [μm], and the diameter of the clad 312 is 230 [μm], but the above sum S3 is in a range falling into the diameter of the core 311. That is, this means that the light transmitted along the front direction D (rightward in the center in FIGS. 12A and 12B) from the front end of the light emitting surface 126 is incident on the core 311 of the hard plastic clad fiber core wire 31H. Therefore, the fitted unit concerning the embodiment of the present invention can realize the optical communication that can be endured sufficiently in practical use.

Because the end face of the core 311 of the hard plastic clad fiber core wire 31H is placed at the aperture 131 and is placed at a proximate position or a contact position opposed to the light emitting surface 126 of the FOT 123, the attenuation of the light irradiated from the light emitting surface 126 can be controlled. This point also contributes to that the fitted unit concerning the embodiment of the present invention can be practically applied to optical communication that can be endured sufficiently.

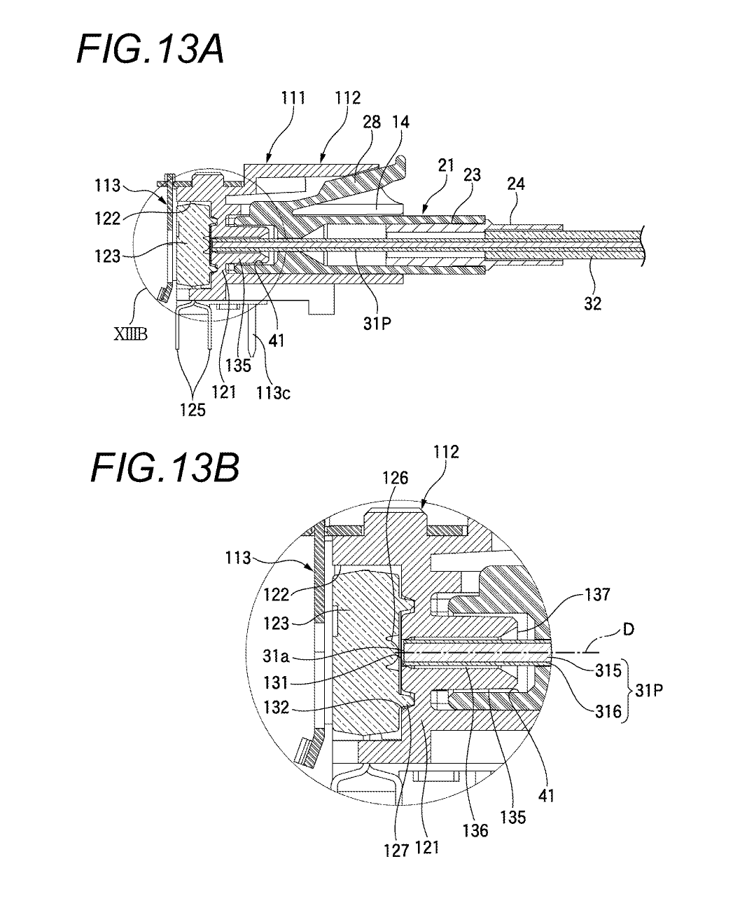

Until now, it was described that the optical connector 21 to which the hard plastic clad fiber core wire 31H is fixed is fixed to the light module 111. Next, it is described that the optical connector 21 to which the plastic optical fiber 31P is fixed is fixed to the light module 111. FIG. 13A is a sectional view which show the internal structure of the light module to which the plastic optical fiber is connected. FIG. 13B is an expanded sectional view of an XIIIb part in FIG. 13A.

In the plastic optical fiber 31P, it is defined as a specification that the diameter of the core 315 is 980 [μm], and the diameter of the clad 316 is 1000 [μm], but the above sum S3 is in a range falling into the diameter of the core 315. Therefore, even if the plastic optical fiber 31P is fixed to the optical connector 21, the fitted unit concerning the embodiment of the present invention can realize the optical communication that can be endured sufficiently in practical use.

### [Another Example of Structures of Fitting an Optical Connector and the Light Module]

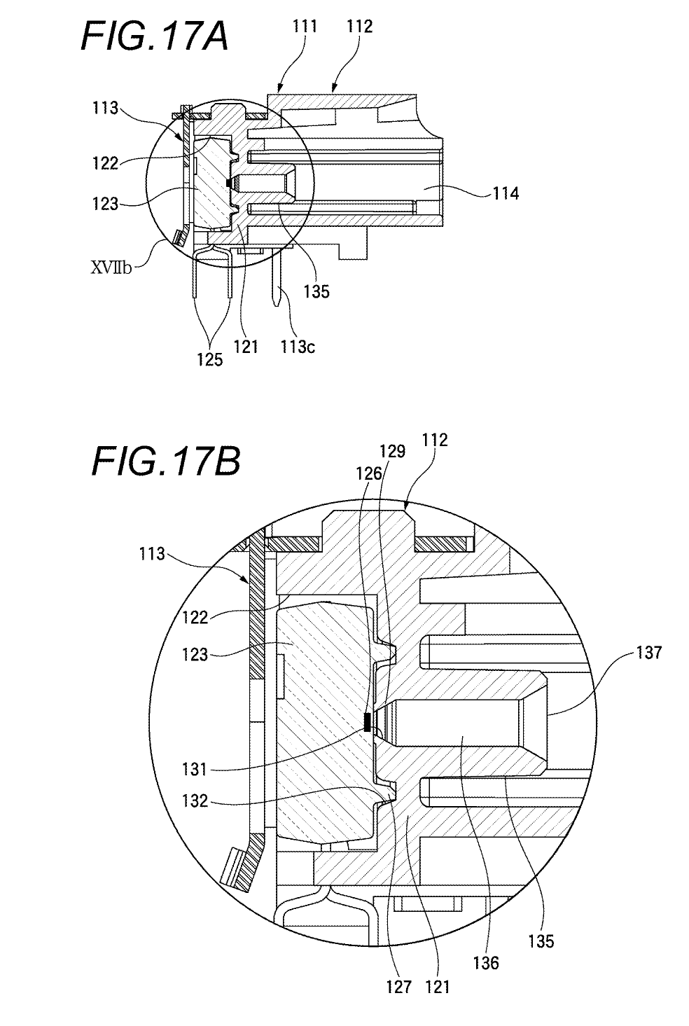

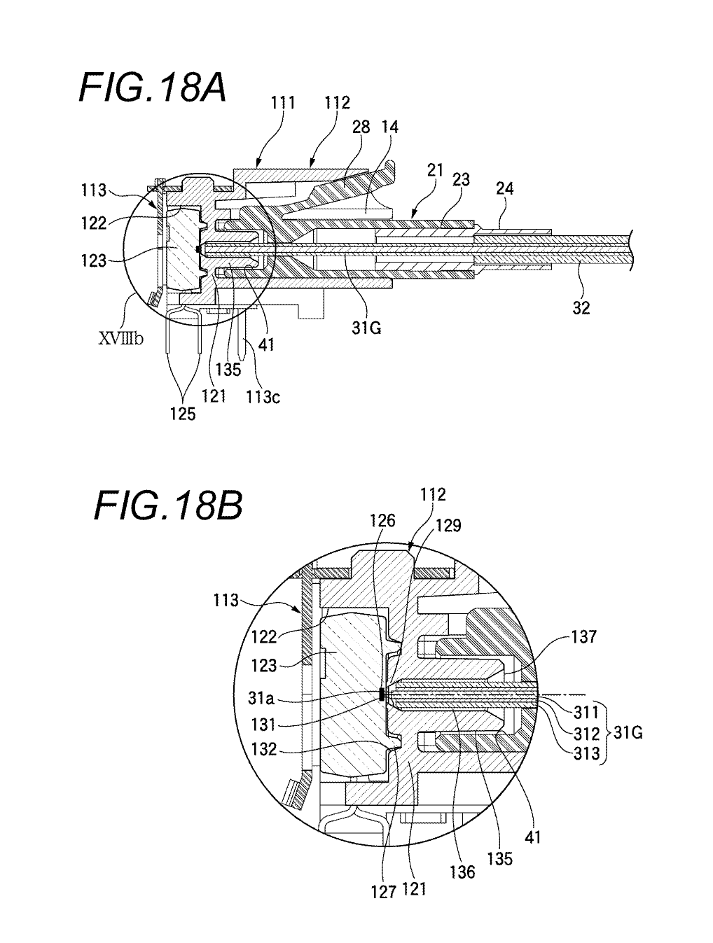

Next, it is described that the optical connectors according to the present embodiments describe above are connected to the light module 111. Here, it is described that the optical connector 21 to which the quartz fiber core wire 31G is fixed is fixed to the light module 111. FIG. 17A is a sectional view which shows the internal structure of the light module. FIG. 17B is an expanded sectional view of an XVIIb part in FIG. 11A. FIG. 18A is a sectional view of the light module to which the quartz fiber is connected. FIG. 18B is an expanded sectional view of an XVIIIb part in FIG. 18A.

As shown in FIGS. 17A and 17B, a light emitting element (VCSEL or LED) 126 is mounted to the FOT 123 near the central surface at the side of the element body 124. Light is irradiated from the light emitting element 126 towards the through hole 136 of the cylindrical part 135 to be described, but the light irradiated from the light emitting element is not condensed and is irradiated towards the front end of an optical fiber with a relatively wide angle.

As shown in FIGS. 18A and 18B, the optical connector 21 described above is attached to an end of the quartz fiber core wire 31G. In terms of the properties of the quartz fiber core wire 31G, it is expected that the front end of the quartz fiber core wire 31G may be close to the light emitting element 126 of the FOT 123. Particularly, to make the end face of the core 311 and the clad 312 of the quartz fiber core wire 31G to be close to the light emitting element 126 of the FOT 123, it is desirable that in the front end 31a of the quartz fiber core wire 31G, the end face of the core 311 and the clad 312 is located closer to the FOT 123 than the end face of the jacket 313. In particular, it is desirable that the end face of the core 311 and the clad 312 is located about 0.1 to 0.2 [mm] closer to the FOT 123 than the end face of the jacket 313.

A taper 129 is formed in the through hole 136 of the housing 112 so that the aperture 131 becomes narrower towards the inner edge of the aperture 131. The diameter of the aperture 131 which becomes smaller due to the taper 129 is smaller than the core diameter of the quartz fiber core wire 31G.

When the optical connector 21 described above is inserted into the optical port part 114 of the light module 111, an end of the quartz fiber core wire 31G is inserted from the aperture 137 into the cylindrical part 135 of the light module 111.

Furthermore, when the optical connector 21 is inserted into the optical port part 114 of the light module 111, the cylindrical part 135 is fitted with the front cylindrical part 41 of the optical connector 21.

Then, the end of the quartz fiber core wire 31G is inserted into the through hole 136 of the cylindrical part 135 of the light module 111. At this time, while the jacket 313 of the quartz fiber core wire 31G is guided by the through hole 136, the jacket 313 plays a role of protecting the core 311 and the clad 312. Furthermore, when the end of the quartz fiber core wire 31G is inserted, while the core 311 is guided in the taper 129, further insertion is regulated at a position where the inside diameter at the taper 129 corresponds to the outer diameter of the core 311. Thus, the end face of the core 311 of the quartz fiber core wire 31G is placed at the aperture 131, and is placed at the proximate position opposed to the light emitting element 126 of the FOT 123. At this time, the core 311 guided by the taper 129 is aligned to the central axis of the cylindrical part 135.

In this state, the latching part 28 of the optical connector 21 engages with the housing 112 of the light module 111, and a connected state of the optical connector 21 to the light module 111 is maintained.

Thereby, the light module 111 becomes in a state that it is possible to well transmit light between the quartz fiber core wire 31G and the light emitting element 126 of the FOT 123. In particular, with the positional relationship between the end face of the above core 311 and clad 312 and the light emitting element 126 of the FOT 123, the core diameter and NA (the number of apertures), with which an input of light level above 1/10 of the illumination of the light emitting element 126 when the front end of the quartz fiber core wire 31G approaches and is connected to the light emitting element 126 of the FOT 123 is expected, can be realized.

For the fitted unit in which the optical connector and the light module are fitted as above, it is expected that the transmission loss of the light transmitted from the light emitting element 126 of the light module 111 to the end face of the core 311 of the quartz fiber core wire 31G can be sufficiently endured in practical use. This greatly depends on the structure of the quartz fiber core wire 31G, the position where the end face of the core 311 of the quartz fiber core wire 31G is placed and the position where the light emitting element 126 is mounted.

Because the end face of the core 311 of the quartz fiber core wire 31G is placed at the aperture 131 and is placed at a proximate position opposed to the light emitting element 126 of the FOT 123 without contacting the light emitting element 126, the attenuation of the light irradiated from the light emitting element 126 can be controlled. This point also contributes to that the fitted unit concerning the embodiment of the present invention can be practically applied to optical communication that can be endured sufficiently.

The present invention is not limited to the above described embodiments, and suitable modifications, improvements or the like can be made. Moreover, the materials, shapes, dimensions, numbers, installation places, and the like of the components in the above embodiments are arbitrarily set as far as the invention can be attained, and not particularly restricted.

The present application is based on Japanese Patent Application No. 2012-160799 filed on Jul. 19, 2012 and Japanese Patent Application No. 2013-005647 filed on Jan. 16, 2013, the contents of which are incorporated herein by reference.

What is claimed is:

1. An optical connector comprising:
an optical cable that includes:
an optical fiber having a core and a clad which covers an outer surface of the core; and
a sheath covering an outer surface of the optical fiber, and wherein a front end part of the optical fiber is exposed from the sheath, and the front end part including a front end of the optical fiber; and
a connector housing that accommodates the front end part of the optical fiber which is exposed from the sheath and holds a part of the front end part of the optical fiber.

2. The optical connector according to claim 1, wherein the optical fiber of the optical cable is a hard plastic clad fiber;
wherein the optical fiber further includes a jacket which covers an outer surface of the clad; and
wherein the connector housing accommodates the front end part of the optical fiber which is exposed from the sheath therein, and presses the outer surface of the jacket to hold the part of the front end part of the optical fiber.

3. The optical connector according to claim 1, wherein the optical fiber of the optical cable is a plastic optical fiber; and
wherein the connector housing accommodates the front end part of the optical fiber which is exposed from the sheath therein, and presses the outer surface of the clad to hold the part of the front end part of the optical fiber.

4. The optical connector according to claim 1, wherein the optical fiber of the optical cable is a quartz fiber;
wherein the optical fiber further includes a jacket which covers an outer surface of the clad; and
wherein the connector housing accommodates the front end part of the optical fiber which is exposed from the sheath therein, and presses the outer surface of the jacket to hold the part of the front end part of the optical fiber.

5. A fitted unit comprising:
an optical connector including:
an optical cable that has:
an optical fiber having a core and a clad which covers an outer surface of the core; and
a sheath covering an outer surface of the optical fiber, and wherein a front end part of the optical fiber is exposed from the sheath, and the front end part including a front end of the optical fiber; and
a connector housing that accommodates the front end part of the optical fiber which is exposed from the sheath and holds a part of the front end part of the optical fiber; and
a light module including:
a fiber optical transceiver which has a light emitting surface for transmitting light between the optical fiber and the fiber optical transceiver; and
a module housing which includes:
a holding part which holds the fiber optical transceiver; and
a cylindrical part having a first aperture which faces the light emitting surface and a second aperture into which the front end part of the optical fiber is inserted, and the module housing being engaged with the connector housing,
wherein a core diameter of the optical fiber is larger than a sum of the maximum tolerances allowed for the optical cable, the connector housing, the fiber optical transceiver, and the module housing, respectively.

6. The fitted unit according to claim 5, wherein the optical fiber of the optical cable is a hard plastic clad fiber;
wherein the optical fiber further includes a jacket which covers an outer surface of the clad; and
wherein the connector housing accommodates the front end part of the optical fiber which is exposed from the sheath therein, and presses the outer surface of the jacket to hold the part of the front end part of the optical fiber.

7. The fitted unit according to claim 5, wherein the optical fiber of the optical cable is a plastic optical fiber; and
wherein the connector housing accommodates the front end part of the optical fiber which is exposed from the sheath therein, and presses the outer surface of the clad to hold the part of the front end part of the optical fiber.
